(19) United States
(12) Patent Application Publication
(10) Pub. No.: US 2004/0021639 A1
(43) Pub. Date: Feb. 5, 2004

(54) Information processing apparatus with double-sided operable keyboard

(75) Inventor: Yasushi Hara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/331,502

(22) Filed: Dec. 31, 2002

(30) Foreign Application Priority Data
Aug. 2, 2002 (JP) 2002-226441

(51) Int. Cl. G09G 5/00

(52) U.S. Cl. 345/168; 361/683

(57) ABSTRACT

An information processing apparatus includes a display apparatus and a keyboard apparatus. The keyboard apparatus is foldable so as to cover a lower part or a part of a display region in the display apparatus, and the bottom surface of the keyboard apparatus is provided with one or a plurality of function keys assigned an arbitrary application. The information processing apparatus further includes a keyboard position detecting part for detecting a relative position of the keyboard apparatus with respect to the display apparatus, thereby switching effective keys between the keys on the upper surface of the keyboard apparatus and those on the bottom surface thereof, in accordance with the relative position of the keyboard apparatus.

### BACKGROUND OF THE INVENTION

1. Field of the Invention

The present invention relates to an information processing apparatus with a double-sided operable keyboard, capable of executing desired application program even in a folded state.

2. Description of the Related Art

Due to the recent rapid spread of personal computers, an environment is increasing in which personal computers are used in a similar manner to that of electrical appliances even in general households. However, most of the personal computers are composed of a display apparatus, a computer body, and a keyboard apparatus, so that it is difficult to keep a space for setting a computer in individual households.

In order to solve the problem regarding such a setting space, for example, JP 2000-259970 A discloses a method for ensuring a use environment of a personal computer without wasting a living space by providing a cavity on a wall surface in a household and setting a personal computer therein.

However, in view of the housing situation in this country, only some households can provide a cavity on a wall surface. Therefore, this cannot be actually a solution to the above problem. Recently, some models have started coming on the market, which has a configuration with a foldable keyboard and is intended to effectively use a space at least during a period of time when computers are not being used.

However, merely with the configuration with a foldable keyboard, the following problems arise.

First, when a keyboard is folded, a personal computer cannot be operated. In the existing circumstance, it takes a considerable amount of time to start up or terminate an operating system, so that it is considered to provide a resume function. This undermines the reason for making a keyboard foldable.

The following is also considered: function keys are arranged on the periphery of a display screen in a configuration where a keyboard is foldable on the display screen, whereby any application may be operated even when the keyboard is folded. However, in this case, irrespective of whether the keyboard is folded or not, the function keys are effective, making an operation complicated to a user, which may cause malfunction.

### SUMMARY OF THE INVENTION

Therefore, with the foregoing in mind, it is an object of the present invention to provide an information processing apparatus with a double-sided operable keyboard, capable of executing desired application program even in the case where a keyboard is folded and keys to be normally operated are directed to a display apparatus side.

In order to achieve the above-mentioned object, an information processing apparatus with a double-sided operable keyboard of the present invention includes a display apparatus and a keyboard apparatus, wherein the keyboard apparatus is foldable so as to cover a lower part or a part of a display region in the display apparatus, and a bottom surface of the keyboard apparatus is provided with one or a plurality of function keys assigned an arbitrary application.

Because of the above configuration, even in the case where a keyboard is folded, and keys to be operated normally are directed to the display apparatus, desired application program can be executed by the operation of function keys.

Furthermore, it is preferable that the information processing apparatus with a double-sided operable keyboard of the present invention includes a keyboard position detecting part for detecting a relative position of the keyboard apparatus with respect to the display apparatus, thereby switching effective keys between keys on an upper surface of the keyboard apparatus and keys on a lower surface of the keyboard apparatus, in accordance with the relative position of the keyboard apparatus. Malfunction between the keys on the upper surface of the keyboard apparatus and those on the bottom surface thereof can be prevented, and key malfunction due to the shock during folding can be prevented.

Furthermore, in the information processing apparatus with a double-sided operable keyboard of the present invention, it is preferable that the keyboard position detecting part detects a tilt angle between the keyboard apparatus and a display part of the display apparatus. This is because the information processing apparatus normally includes a rotation part for folding the keyboard apparatus at the bottom of an information processing apparatus body.

Furthermore, it is preferable that the information processing apparatus with a double-sided operable keyboard of the present invention is thin and wall-hung.

These and other advantages of the present invention will become apparent to those skilled in the art upon reading and understanding the following detailed description with reference to the accompanying figures.

### BRIEF DESCRIPTION OF THE DRAWINGS

FIGS. 1A and 1B are views showing a configuration of an information processing apparatus with a double-sided operable keyboard of an embodiment according to the present invention.

FIGS. 2A and 2B are views showing a configuration of a keyboard apparatus in the double-sided operable keyboard of the embodiment according to the present invention.

FIG. 3 illustrates a configuration of the information processing apparatus with a double-sided operable keyboard of the embodiment according to the present invention.

FIG. 4 illustrates the detection of a keyboard position in the information processing apparatus with a double-sided operable keyboard of the embodiment according to the present invention.

### DESCRIPTION OF THE PREFERRED EMBODIMENTS

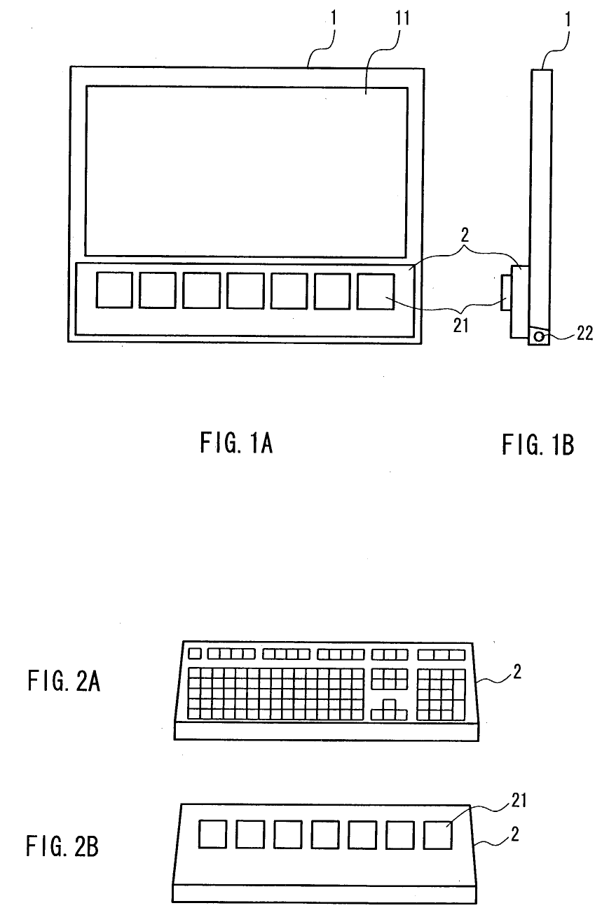

Hereinafter, an information processing apparatus with a double-sided operable keyboard of an embodiment according to the present invention will be described with reference to the drawings. FIGS. 1A and 1B are views showing a configuration of an information processing apparatus with a double-sided operable keyboard of the embodiment according to the present invention. FIG. 1A shows a front view of the information processing apparatus with a double-sided operable keyboard of the embodiment according to the present invention. FIG. 1B shows a right side view of the information processing apparatus with a double-sided operable keyboard of the embodiment according to the present invention.

In the present embodiment, the case where the information processing apparatus is thin and can be wall-hung will be described. Needless to say, the configuration of the information processing apparatus is not particularly limited thereto.

In FIG. 1A, reference numeral 11 denotes a display region in an information processing apparatus body 1, and a liquid crystal screen or the like is used often for a display of the thin information processing apparatus 1. Reference numeral 2 denotes a keyboard apparatus. As shown in FIG 1B, the keyboard apparatus 2 is folded toward the display region 11 by using a rotation part 22. In this state, function keys 21 are operable on a surface directed in the same direction as that of the display region 11 of the keyboard apparatus 2.

FIGS. 2A and 2B show a configuration of the keyboard apparatus 2 in the information processing apparatus with a double-sided operable keyboard of the embodiment according to the present invention. FIG. 2A shows a front view of the keyboard apparatus 2 in the information processing apparatus with a double-sided operable keyboard of the embodiment according to the present invention. FIG. 2B shows a bottom view of the keyboard apparatus 2 in the information processing apparatus with a double-sided operable keyboard of the embodiment according to the present invention.

As shown in FIG. 2A, keys similar to those of a normal keyboard apparatus are arranged on an upper surface of the keyboard apparatus 2. There is no particular constraint to the height of each key. The height of the keys only need to be in such a range as that the keyboard apparatus 2 can be folded with respect to the rotation part 22.

Furthermore, as shown in FIG. 2B, the bottom surface of the keyboard apparatus 2 has a configuration in which function keys 21 provided with particular functions are arranged so that any application can be operated even in the case where the keyboard apparatus 2 is folded with respect to the rotation part 22.

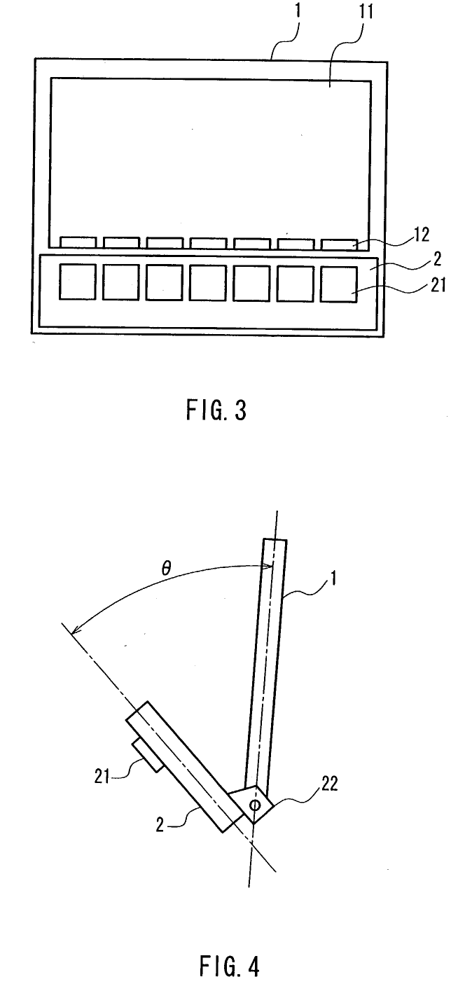

As a method for confirming which function is assigned to which function key 21 under the condition that the keyboard apparatus 2 is folded, various methods are considered. For example, as shown in FIG. 3, it is considered that a key display region 12 showing functions assigned to the respective function keys 21 in a folded state is provided in a lower part of the display region 11. Needless to say, the present invention is not limited to such a display method. Any method may be used as long as it clearly demonstrates which function is assigned to which function key 21 positioned on the bottom surface of the keyboard apparatus 2.

It is also considered that a keyboard position detecting part is provided for detecting an angle between the keyboard apparatus 2 and the information processing apparatus body 1 including the display region 11 at all times, whereby effective keys are switched between the keys on the upper surface of the keyboard apparatus 2 or the function keys on the bottom surface in accordance with an angle. More specifically, as shown in FIG. 4, an angle θ between the keyboard apparatus 2 and the information processing apparatus body 1 including the display region 11 is detected at all times. For example, in the case where θ is smaller than 45°, only the function keys 21 on the bottom surface of the keyboard apparatus 2 become effective, and in the case where θ is equal to or larger than 45°, the keys on the upper surface of the keyboard apparatus 2 become effective.

With such a configuration, malfunction can be prevented when the keys on the upper surface of the folded keyboard apparatus 2 are pressed with a pressure pressing the reverse surface. Furthermore, malfunction can be prevented when the keys on the upper surface of the keyboard apparatus 2 are pressed due to the shock during folding.

As described above, according to the present embodiment, even in the case where a keyboard is folded, and keys to be operated normally are directed to the display apparatus, desired application processing can be conducted by the operation of function keys.

Furthermore, the keys present on either surface of the keyboard apparatus body become effective based on a tilt angle between the information processing apparatus body and the keyboard apparatus. Therefore, malfunction between the keys on the upper surface and those on the bottom surface can be prevented, and key malfunction caused by the shock during folding can be prevented.

As described above, in the information processing apparatus with a double-sided operable keyboard, even in the case where a keyboard is folded, and keys to be operated normally are directed to the display apparatus side, desired application processing can be conducted by operating the function keys.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information processing apparatus with a double-sided operable keyboard, comprising a display apparatus and a keyboard apparatus,
wherein the keyboard apparatus is foldable so as to cover a lower part or a part of a display region in the display apparatus, and
a bottom surface of the keyboard apparatus is provided with one or a plurality of function keys assigned an arbitrary application.

2. An information processing apparatus with a double-sided operable keyboard according to claim 1, comprising a keyboard position detecting part for detecting a relative position of the keyboard apparatus with respect to the display apparatus, thereby switching effective keys between keys on an upper surface of the keyboard apparatus and keys on a lower surface of the keyboard apparatus, in accordance with the relative position of the keyboard apparatus.

3. An information processing apparatus with a double-sided operable keyboard according to claim 2, wherein the keyboard position detecting part detects a tilt angle between the keyboard apparatus and a display part of the display apparatus.

4. An information processing apparatus with a double-sided operable keyboard according to claim 1, wherein the information processing apparatus is thin and wall-hung.

5. An information processing apparatus with a double-sided operable keyboard according to claim 2, wherein the information processing apparatus is thin and wall-hung.

6. An information processing apparatus with a double-sided operable keyboard according to claim 3, wherein the information processing apparatus is thin and wall-hung.
